(19) United States
(12) Patent Application Publication
(10) Pub. No.: US 2025/0203176 A1
(43) Pub. Date: Jun. 19, 2025

(54) SERVER, TERMINAL AND METHOD

(71) Applicant: 17LIVE Japan Inc., Tokyo (JP)

(72) Inventors: Wan-Jou HSIEH, Taipei City (TW); Ching-Jan WANG, Taipei City (TW); Kuan-Ying CHEN, Taipei City (TW); Chen-Ling CHUANG, Taipei City (TW)

(21) Appl. No.: 18/968,624

(22) Filed: Dec. 4, 2024

(30) Foreign Application Priority Data
Dec. 13, 2023 (JP) 2023-210603

(51) Int. Cl. H04N 21/854; H04N 21/2187; H04N 21/431; H04N 21/4784

(52) U.S. Cl. CPC H04N 21/854; H04N 21/2187; H04N 21/4312; H04N 21/4784

(57) ABSTRACT

A server includes a circuitry configured to transmit video data related to a livestream to a terminal of a viewer over a network; determine whether a condition is satisfied, the condition being related to at least one of gifting or a comment during the livestream; send a notification to the terminal of the viewer over the network upon determination that the condition is satisfied; and perform a process to create video data relating to a portion of the livestream in association with the viewer upon reception of a response to the notification from the terminal of the viewer over the network.

### CROSS-REFERENCE TO RELATED APPLICATIONS

This application is based on and claims the benefit of priority from Japanese Patent Application Serial No. 2023-210603 (filed on Dec. 13, 2023), the contents of which are hereby incorporated by reference in their entirety.

### TECHNICAL FIELD

The present disclosure relates to a server, a terminal and a method.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video streaming services also became popular as storage costs were reduced.

And nowadays or in the Reiwa period (2019 to present), with the sophistication of smartphones and further improvements in network speed as typified by 5G, services that enable real-time communication through video, especially livestreaming services, are gaining recognition. The number of users of livestreaming services is expanding, especially among young people, as such services allow people to share the same good time even when they are in the separate locations from each other.

Japanese Patent Application Publication No. 2021-158612 (“the '612 Publication”) discloses a technique of presenting a list of live videos to a viewer who is currently selecting a video to watch. The list is provided by a system and made by automatically trimming the liveliest parts of the live videos. This technique can facilitate the viewer's process of selecting a live video.

In the conventional art, clips of livestreams are made by their livestreamers or a system (see, for example, the '612 Publication), not by viewers. Therefore, the number of clips generated or shared does not increase. Such clips are advantageously shareable, but this advantage is wasted.

### SUMMARY

In view of the above, one object of the present disclosure is to provide a technology that can further stimulate livestream clipping.

An aspect of the present disclosure is related to a server. The server includes a circuitry configured to transmit video data related to a livestream to a terminal of a viewer over a network; determine whether a condition is satisfied, the condition being related to at least one of gifting or a comment during the livestream; send a notification to the terminal of the viewer over the network upon determination that the condition is satisfied; and perform a process to create video data relating to a portion of the livestream in association with the viewer upon reception of a response to the notification from the terminal of the viewer over the network.

Another aspect of the present disclosure is related to a terminal of a viewer of a livestream. The terminal includes one or more processors; and memory storing one or more computer programs configured to be executed by the one or more processors. The one or more computer programs include instructions for causing the terminal of the viewer of the livestream to: receive video data related to the livestream from a server over a network; upon determination that a condition relating to at least one of gifting or a comment is satisfied during the livestream, start displaying an indication, on a screen showing the livestream, encouraging the viewer to issue an instruction to create video data relating to a portion of the livestream in association with the viewer.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### Advantageous Effects of the Disclosure

According to the aspects of the disclosure, livestream clipping can be further stimulated.

### BRIEF DESCRIPTION OF THE DRAWINGS

FIG. 1 schematically illustrates a configuration of a livestreaming system according to one embodiment of the disclosure.

FIG. 2 is a block diagram showing functions and configuration of a user terminal in FIG. 1.

FIG. 3 is a block diagram showing functions and configuration of a server in FIG. 1.

FIG. 4 is a data structure diagram showing an example of a stream DB in FIG. 3.

FIG. 5 is a data structure diagram showing an example of a user DB in FIG. 3.

FIG. 6 is a data structure diagram showing an example of a gift DB in FIG. 3.

FIG. 7 is a data structure diagram showing an example of a clip DB in

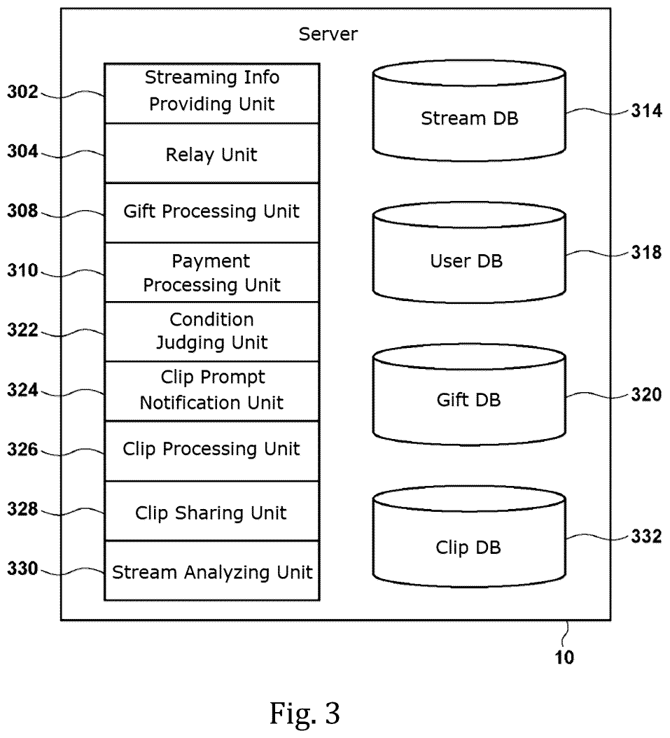

FIG. 3.

FIG. 8 is a flow chart showing a series of steps performed in the livestreaming system when a clip prompt notification is issued during a livestream.

FIG. 9 is a representative screen image of a livestreaming room screen appearing on the display of a viewer's user terminal.

FIG. 10 is a representative screen image of a livestreaming room screen on which a gift region is superimposed on the display of the viewer's user terminal.

FIG. 11 is a representative screen image of a livestreaming room screen on which an effect is superimposed on the display of the viewer's user terminal.

FIG. 12 is a representative screen image of a livestreaming room screen including a system comment related to a clip prompt in a comment display region on the display of the viewer's user terminal.

FIG. 13 is a representative screen image of a clip share screen appearing on the display of the viewer's user terminal.

FIG. 14 is a representative screen image of a livestreaming room screen appearing on the display of a streamer's user terminal.

FIG. 15 is a representative screen image of a livestream result screen appearing on the display of the user terminal of the streamer who has finished livestreaming.

FIG. 16 is a block diagram showing an example of hardware configuration of an information processing device according to the embodiment.

### DESCRIPTION OF THE PREFERRED EMBODIMENTS

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

A livestreaming system relating to an embodiment allows a viewer of a livestream to create a short video by clipping a portion of the livestream, so that the viewer can share the created short video with others or watch it again later. Such a portion of a livestream, or video data related to it is referred to as a clip of the livestream. The clip is associated with the viewer who has created it. In the present embodiment, a server monitors a livestream and transmits a clip prompt notification to user terminals of all of the viewers watching the livestream if a clip prompt notification condition is satisfied which is related to gifts and/or comments made during the livestream. On reception of the clip prompt notification, the user terminals start displaying a message to encourage the viewers to create a clip. On reception of a clip creation instruction from any of the viewers, the server and user terminals perform a clip generation process.

Specifically, memorable or the best moments may occur in a livestream when, for example, a very expensive gift is used, a lottery jackpot is hit, or comments are frequently posted due to lively communication. In such cases, the viewers of the livestream are encouraged to create a clip for those moments in the present embodiment. This makes it easy for the viewers to create a clip for the memorable moments, and also prevents the viewers from missing the chance of obtaining a clip for the memorable moments. Since the clip prompt notification is sent to all of the viewers of the livestream, the number of clips generate increases, so that the best moments of the livestream can be spread by more viewers and shared on more occasions. The livestream and its livestreamer can thus acquire increased media exposure, thereby obtaining better recognition rate.

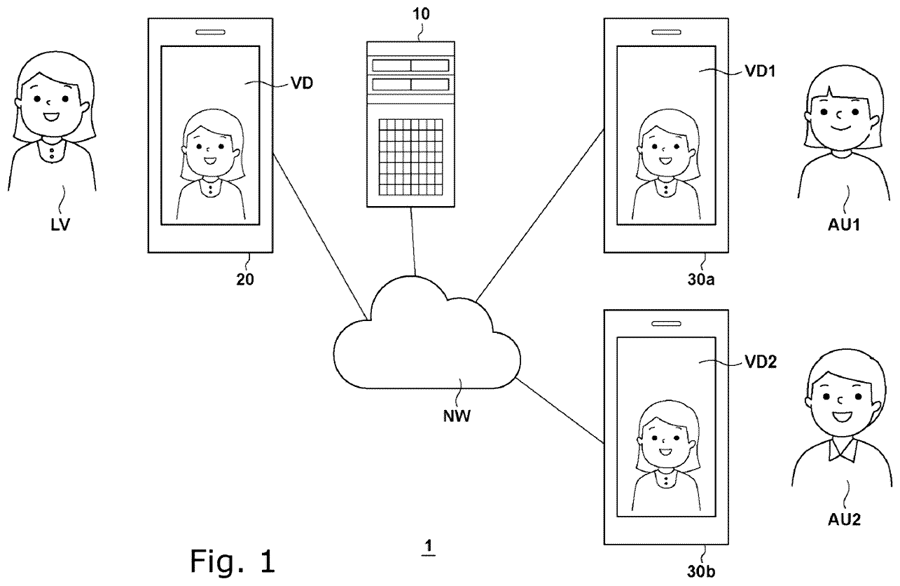

FIG. 1 schematically illustrates the configuration of a livestreaming system 1 according to one embodiment of the disclosure. The livestreaming system 1 provides an interactive livestreaming service that allows a livestreamer LV (also referred to as a liver or streamer) and viewers AU (also referred to as audience) (AU1, AU2, . . . ) to communicate in real time. As shown in FIG. 1, the livestreaming system 1 includes a server 10, a user terminal 20 on the livestreamer side, and user terminals 30 (30a, 30b . . . ) on the audience side. In addition to the livestreamer who is livestreaming and the viewers who are watching the livestream, there may be users who have logged in the livestreaming platform but is neither livestreaming nor watching the livestream. Such users are herein referred to as active users. The livestreamer, viewers, and active users may be collectively referred to as users. The server 10 may be constituted by one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, user terminal 20, and user terminals 30 are interconnected so as to be able to communicate with each other over the various wired or wireless networks NW.

The livestreaming system 1 involves the livestreamer LV, the viewers AU, and an administrator (not shown) who manages the server 10. The livestreamer LV is a person who broadcasts contents in real time by recording the contents with his/her user terminal 20 and uploading them directly to the server 1. Examples of the contents may include the livestreamer's own songs, talks, performances, fortune-telling, gameplays, and any other contents. The administrator provides a platform for livestreaming contents on the server 10, and also mediates or manages real-time interactions between the livestreamer LV and the viewers AU. The viewers AU access the platform through their user terminals 30 to select and view a desired content. During livestreaming of the selected content, the viewer AU performs operations to comment, cheer, or ask fortune-telling via the user terminal 30, the livestreamer LV who is delivering the content responds to such a comment, cheer, or request and such response is transmitted to the viewer AU via video and/or audio, thereby establishing an interactive communication.

As used herein, the term “livestreaming” or “livestream” may mean a mode of data transmission that allows a content recorded at the user terminal 20 of the livestreamer LV to be played and viewed at the user terminals 30 of the viewers AU substantially in real time, or it may mean a live broadcast realized by such a mode of transmission. The livestreaming may be achieved using existing livestreaming technologies such as HTTP Live Streaming, Common Media Application Format, Web Real-Time Communications, Real-Time Messaging Protocol and MPEG DASH. The livestreaming includes a transmission mode in which, while the livestreamer LV is recording contents, the viewers AU can view the contents with a certain delay. The delay is acceptable as long as interaction between the livestreamer LV and the viewers AU can be at least established. Note that the livestreaming is distinguished from so-called on-demand distribution, in which contents are entirely recorded and the entire data is once stored on the server and the server provides users with the data at any subsequent time upon request from the users.

The term “video data” herein refers to data that includes image data (also referred to as moving image data) generated using an image capturing function of the user terminals 20 and 30 and audio data generated using an audio input function of the user terminals 20 and 30. Video data is reproduced in the user terminals 20 and 30, so that the users can view contents. In this embodiment, it is assumed that between video data generation at the livestreamer's user terminal and video data reproduction at the viewer's user terminal, processing is performed onto the video data to change its format, size, or specifications of the data, such as compression, decompression, encoding, decoding, or transcoding. However, such processing does not substantially change the content (e.g., video images and audios) represented by the video data, so that the video data after such processing is herein described as the same as the video data before such processing. In other words, when video data is generated at the livestreamer's user terminal, transmitted via the server 10, and then reproduced at the viewer's user terminal, the video data generated at the livestreamer's user terminal, the video data that passes through the server 10, and the video data received and reproduced at the viewer's user terminal are all the same video data.

As used herein, the term “streaming duration” is a parameter associated with a livestream and refers to the length of time the livestream lasts. The streaming duration is calculated independently from whether the corresponding livestream is watched by any viewers.

In the example in FIG. 1, a livestreamer LV is livestreaming his/her talk. The user terminal 20 of the livestreamer LV generates video data by recording images and sounds of the livestreamer LV who is talking, and the generated video data is transmitted to the server 10 over the network NW. At the same time, the user terminal 20 displays the recorded video image VD of the livestreamer LV on the display of the user terminal 20 to allow the livestreamer LV to check the livestream currently performed.

The respective user terminals 30a and 30b of the viewers AU1 and AU2, who have requested the platform to enable them to view the livestream of the livestreamer LV, receive video data related to the livestream over the network NW and reproduce the received video data, to display video images VD1 and VD2 on the displays and output audio through the speakers. The video images VD1 and VD2 displayed at the user terminals 30a and 30b, respectively, are substantially the same as the video image VD captured by the user terminal 20 of the livestreamer LV, and the audio outputted at the user terminals 30a and 30b is substantially the same as the audio recorded by the user terminal 20 of the livestreamer LV.

Recording of the images and sounds at the user terminal 20 of the livestreamer LV and reproduction of the video data at the user terminals 30a and 30b of the viewers AU1 and AU2 are performed substantially simultaneously. The viewer AU1 may type a comment about the talk of the livestreamer LV on the user terminal 30a, and the server 10 may display the comment on the user terminal 20 of the livestreamer LV in real time and also display the comment on the user terminals 30a and 30b of the viewers AU1 and AU2, respectively. The livestreamer LV may read the comment and develop his/her talk to cover and respond to the comment, and the video and sound of the talk are output on the user terminals 30a and 30b of the viewers AU1 and AU2, respectively. This interactive action is recognized as establishment of a conversation between the livestreamer LV and the viewer AU1. In this way, the livestreaming system 1 realizes a livestream that enables the interactive communication, not one-way communication.

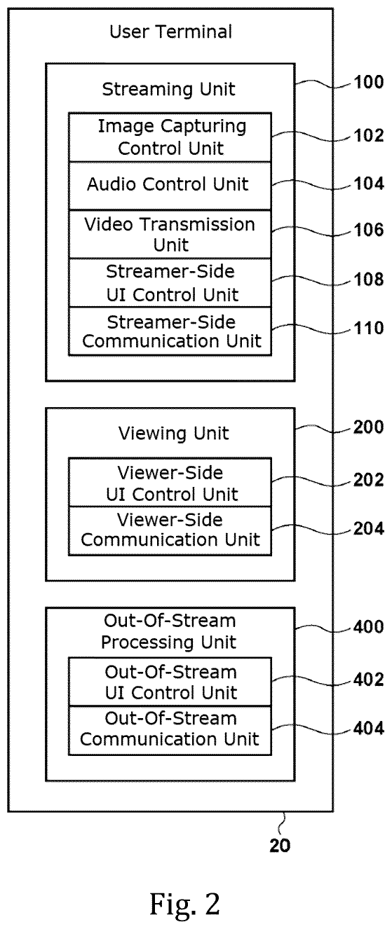

FIG. 2 is a block diagram showing functions and configuration of the user terminal 20 of FIG. 1. The user terminals 30 have the same functions and configuration as the user terminal 20. The blocks in FIG. 2 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The livestreamer LV and the viewers AU download and install a livestreaming application program (hereinafter referred to as a livestreaming application), onto the user terminals 20 and 30 from a download site over the network NW. Alternatively, the livestreaming application may be pre-installed on the user terminals 20 and 30. When the livestreaming application is executed on the user terminals 20 and 30, the user terminals 20 and 30 communicate with the server 10 over the network NW to implement various functions. Hereinafter, the functions implemented by (processors such as CPUs of) the user terminals 20 and 30 running the livestreaming application will be described as functions of the user terminals 20 and 30. These functions are realized in practice by the livestreaming application on the user terminals 20 and 30. In any other embodiments, these functions may be realized by a computer program written in a programming language such as HTML (HyperText Markup Language), which is transmitted from the server 10 to web browsers of the user terminals 20 and 30 over the network NW and executed by the web browsers.

The user terminal 20 includes a streaming unit 100 for generating a video data in which the user's image and sound are recorded and providing the video data to the server 10, a viewing unit 200 for acquiring and reproducing the video data from the server 10, and an out-of-stream processing unit 400 for processing requests made by active users. The user activates the streaming unit 100 to livestream, the viewing unit 200 to view a livestream, and the out-of-stream processing unit 400 to look for a livestream, view a livestreamer's profile, or watch an archive or clip. The user terminal having the streaming unit 100 activated is the livestreamer's terminal, i.e., the user terminal that generates video data, the user terminal having the viewing unit 200 activated is the viewer's terminal, i.e., the user terminal that reproduces video data, and the user terminal having the out-of-stream processing unit 400 activated is the active user's terminal.

The streaming unit 100 includes an image capturing control unit 102, an audio control unit 104, a video transmission unit 106, a streamer-side UI control unit 108, and a streamer-side communication unit 110. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time.

The streamer-side UI control unit 108 controls a UI for the livestreamer. The streamer-side UI control unit 108 is connected to a display (not shown in FIG. 2), and displays a video image on the display by reproducing the video data that is to be transmitted by the video transmission unit 106. The streamer-side UI control unit 108 is also connected to input means (not shown in FIG. 2) such as touch panels, keyboards, and displays, and obtains the livestreamer's input via the input means. The streamer-side UI control unit 108 superimposes a predetermined frame image on the video image. The frame image includes various user interface objects (hereinafter simply referred to as “objects”) for receiving inputs from the live-streamer, comments entered by the viewers, and system comments generated by the server 10. The streamer-side UI control unit 108 receives, for example, the live-streamer's inputs made by the live-streamer tapping the objects.

The streamer-side communication unit 110 controls communication with the server 10 during a livestream. The streamer-side communication unit 110 transmits the content of the livestreamer's input that has been obtained by the streamer-side UI control unit 108 to the server 10 over the network NW. The streamer-side communication unit 110 receives various information associated with the livestream from the server 10 over the network NW.

The viewing unit 200 includes a viewer-side UI control unit 202 and a viewer-side communication unit 204. The viewer-side communication unit 204 controls communication with the server 10 during a livestream. The viewer-side communication unit 204 receives, from the server 10 over the network NW, video data related to the livestream in which the livestreamer and the viewer participate or a clip prompt notification.

The viewer-side UI control unit 202 controls the UI for the viewer. The viewer-side UI control unit 202 is connected to a display and a speaker (not shown in FIG. 2), and reproduces the received video data so that video images are displayed on the display and sounds are output through the speaker. The state where the images and sounds are respectively output through the display and speaker can be referred to as “the video data is reproduced”. The viewer-side UI control unit 202 is also connected to input means (not shown in FIG. 2) such as touch panels, keyboards, and displays, and obtains the viewer's input via the input means. The viewer-side UI control unit 202 superimposes a predetermined frame image on an image generated from the video data obtained from the server 10. The frame image includes various objects for receiving inputs from the viewer, comments entered by the viewer, and system comments generated by the server 10. The viewer-side communication unit 204 transmits the content of the viewer's input that has been obtained by the viewer-side UI control unit 202 to the server 10 over the network NW. The viewer-side communication unit 204 transmits a clip creation instruction to the server 10 over the network NW.

The out-of-stream processing unit 400 includes an out-of-stream UI control unit 402 and an out-of-stream communication unit 404. The out-of-stream UI control unit 402 controls a UI for the active user. For example, the out-of-stream UI control unit 402 generates a livestream selection screen and shows the screen on the display. The livestream selection screen presents a list of livestreams to which the active user is currently invited to participate, to allow the active user to select a live stream. The out-of-stream UI control unit 402 generates a profile screen for any user and shows the screen on the display. The out-of-stream UI control unit 402 plays back an archive generated by recording past livestreams. The out-of-stream UI control unit 402 generates a clip selection screen and shows the screen on the display. The clip selection screen presents a list of clips to which the active user is related, to allow the active user to select a clip. The out-of-stream UI control unit 402 reproduces the selected clip.

The out-of-stream communication unit 404 controls communication with the server 10 that takes place outside a livestream. The out-of-stream communication unit 404 receives, from the server 10 over the network NW, information necessary to generate the livestream selection screen, information necessary to generate the profile screen, archived data and information necessary to generate the clip selection screen. The out-of-stream communication unit 404 transmits the content of the active user's input to the server 10 over the network NW.

FIG. 3 is a block diagram showing functions and configuration of the server 10 of FIG. 1. The server 10 includes a stream information providing unit 302, a relay unit 304, a gift processing unit 308, a payment processing unit 310, a condition judging unit 322, a clip prompt notification unit 324, a clip processing unit 326, a clip sharing unit 328, a stream analyzing unit 330, a stream DB 314, a user DB 318, a gift DB 320, and a clip DB 332.

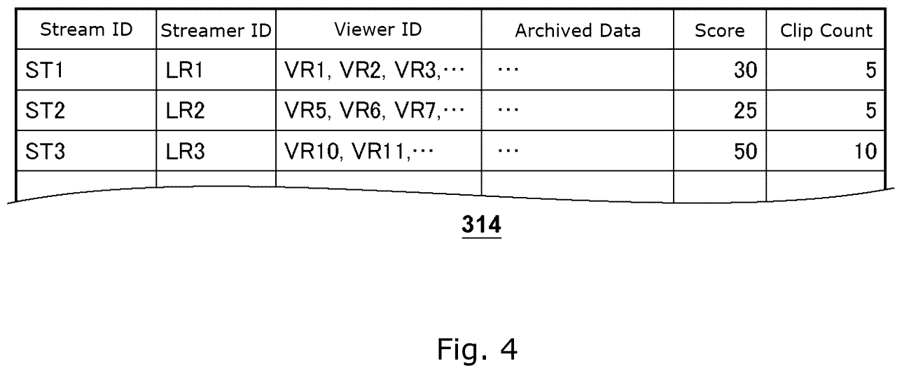

FIG. 4 is a data structure diagram showing an example of the stream DB 314 of FIG. 3. The stream DB 314 holds information regarding livestreams currently taking place and information regarding livestreams that have taken place in the past (also referred to as “archived livestreams”). The stream DB 314 stores an stream ID for identifying a livestream on a livestreaming platform provided by the livestreaming system 1, a streamer ID, which is a user ID for identifying the livestreamer who provides the livestream, a viewer ID, which is a user ID for identifying a viewer of the livestream, archived data of the livestream, a score of the livestream, a clip count indicating the number of times clips are created from the livestream by the viewers of the livestream, in association with each other. The number of times clips are created from the livestream may be indicated by the above-mentioned clip count, but alternatively or additionally by information such as the number of clips created including the clips created by the livestreamer, the number of viewers who has created clips from the livestream, a level representing the number of times clips are created, or the number of clips created from the livestream by the viewers of the livestream.

The score of the livestream is an indicator of viewers' engagement with the livestream. A livestream with a high score value is recognized as “lively” or “popular”. The score varies depending on, for example, the number of viewers, streaming time, number of comments, number of shares, number of gifts received, number of viewers who gave gifts, number of cheers and number of clips. Specifically, the score is calculated by an algorithm configured to raise the score as the number of clips increases. The higher the score, the higher or more prominent the thumbnail of that livestream is displayed on the livestream selection screen. Therefore, the higher the score, the livestream will catch the attention of more active users.

The archived data of the livestream is video data of the livestream from its start to the present if the livestream is currently taking place, or video data of the entire livestream if the livestream occurred in the past. The archived data includes video data generated by the livestreamer's user terminal and data of objects such as gift effects and comments superimposed on the video. The video data and object data of the archived data may be retained as a single piece of data or different pieces of data. The same applies to data of clips, which are copies of portions of the archived data.

In the livestreaming platform provided by the livestreaming system 1 of the embodiment, when a user delivers a livestream, the user is referred to as a livestreamer, and when the same user views a livestream delivered by another user, the user is referred to as a viewer. Therefore, the distinction between a livestreamer and a viewer is not fixed, and a user ID registered as a livestreamer ID at one time may be registered as a viewer ID at another time.

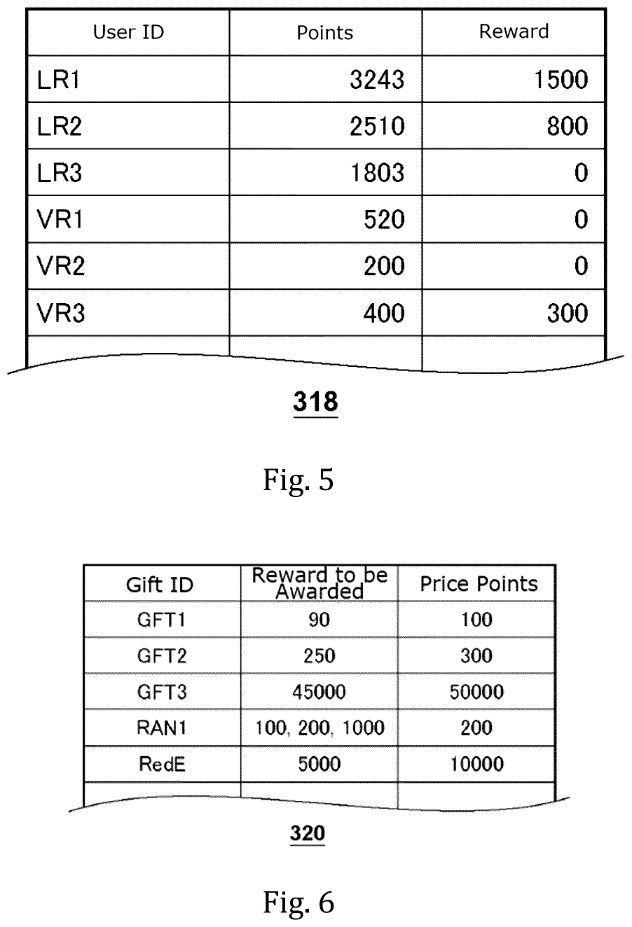

FIG. 5 is a data structure diagram showing an example of the user DB 318 of FIG. 3. The user DB 318 holds information regarding users. The user DB 318 stores a user ID identifying a user, points owned by the user, and a reward awarded to the user, in association with each other.

The points are an electronic representation of value circulated in the live-streaming platform. The user can purchase the points using a credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by a corresponding amount.

FIG. 6 is a data structure diagram showing an example of the gift DB 320 of FIG. 3. The gift DB 320 holds information regarding gifts available for the viewers in livestreams. A gift is a digital item or electronic data with the following characteristics:
It can be purchased in exchange for the points or money, or can be given for free.
It can be given by a viewer to a livestreamer. Giving a gift to a livestreamer is also referred to as using the gift or throwing the gift.
Some gifts may be purchased and used at the same time, and some gifts may be used by the viewer at any time after purchased.
When a viewer gives a gift to a livestreamer, the livestreamer is awarded a corresponding reward.
When a gift is used, the use may trigger an effect associated with the gift. For example, an effect corresponding to the gift will appear on the livestreaming room screen.

The gift DB 320 stores: a gift ID for identifying a gift; a reward to be awarded, which is a reward awarded to a livestreamer when the gift is given to the livestreamer; and price points, which is the amount of points to be paid for use of the gift, in association with each other. A viewer is able to give a desired gift to a livestreamer by paying the price points of the desired gift while viewing the livestream. The payment of the price points may be made by appropriate electronic payment means. For example, the payment may be made by the viewer paying the price points to the administrator. Alternatively, bank transfers or credit card payments may be available. The administrator can freely determine the relationship between the reward to be awarded and the price points. For example, the administrator may determine that the reward to be awarded=the price points. Alternatively, points obtained by multiplying the reward to be awarded by a predetermined coefficient such as 1.2 may be set as the price points, or points obtained by adding predetermined fee points to the reward to be awarded may be set as the price points.

In the present embodiment, normal gifts (e.g., “GFT1”, “GFT2”) are provided, and three different types of special gifts are additionally provided as follows.

(1) Expensive gifts that can be purchased at price points equal to or higher than a threshold value (=30000). Example: “GFT3.” An expensive gift is associated with a more noticeable effect than is a normal gift. Specifically, noticeable effects last long, have a large data size, look attractive or flamboyant, for example.

(2) Random gifts that can give a livestreamer a reward determined by a drawing. Example: “RAN1.” When a gift “RAN1” is used, 200 points are subtracted from the points owned by the viewer who has used the gift, and a drawing is held. The drawing results in 100, 200 or 1000 points to be given to the livestreamer. If the result of the drawing is 1000 points, which is higher than the price points of the gift “RAN1,” this means a win. The random gifts may be configured using the random gift technology disclosed in “Let's Learn Basics of Gifts!,” 17Live, URL: https://jp.17.live/userguide/20103/.

(3) Interaction gifts that, when used, invites the viewer and/or livestreamer to make a further action. Example: “RedE.” When used, a gift “RedE” can give a chance of obtaining points to the viewers who are watching the livestream in which the interaction gift is used. The interaction gifts may be configured using, for example, the lucky bag technology disclosed in “Lucky Bag,” 17Live Help, URL: https://17live-jp.zendesk.com/hc/ja/articles/6780744668303-% E3%83% A9% E3%83%83% E3% 82% AD % E3%83% BC % E8% A2%8B

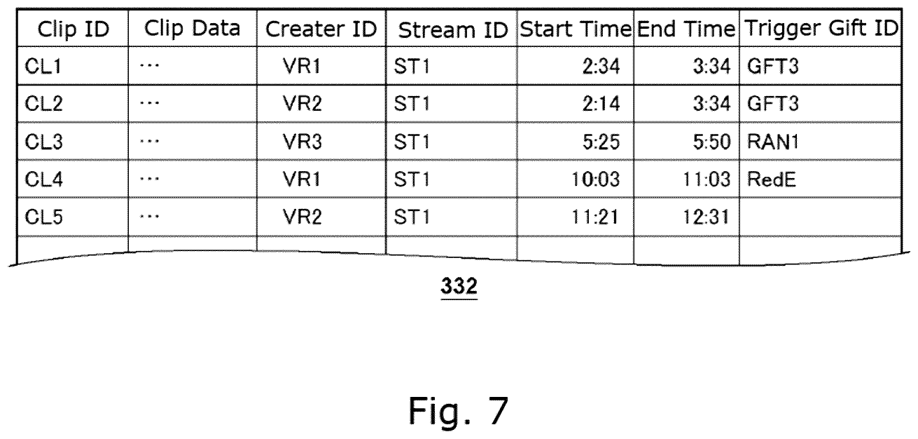

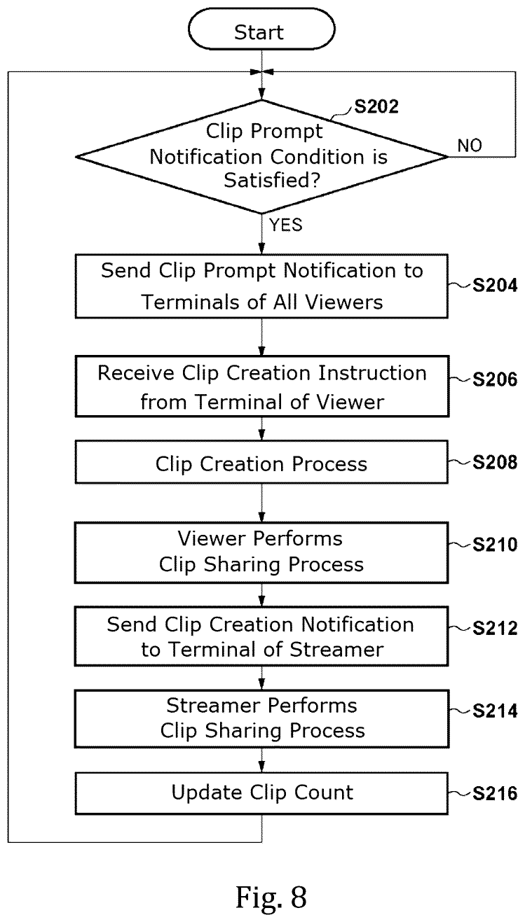

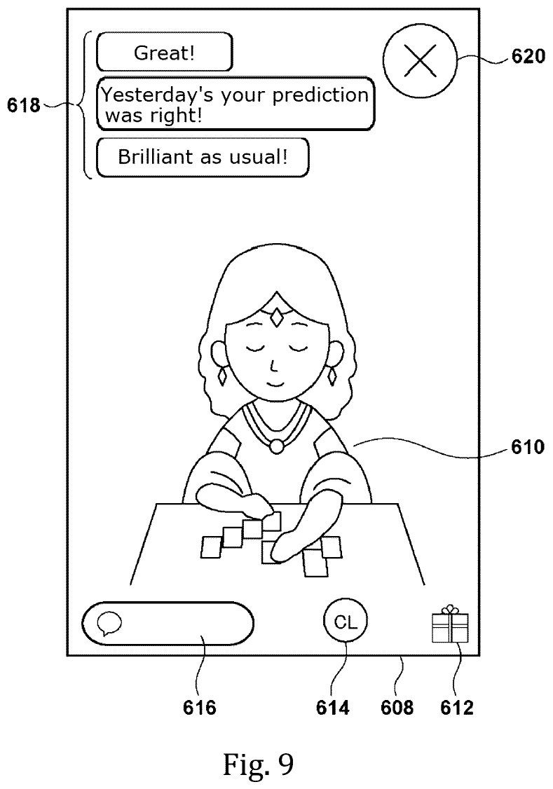

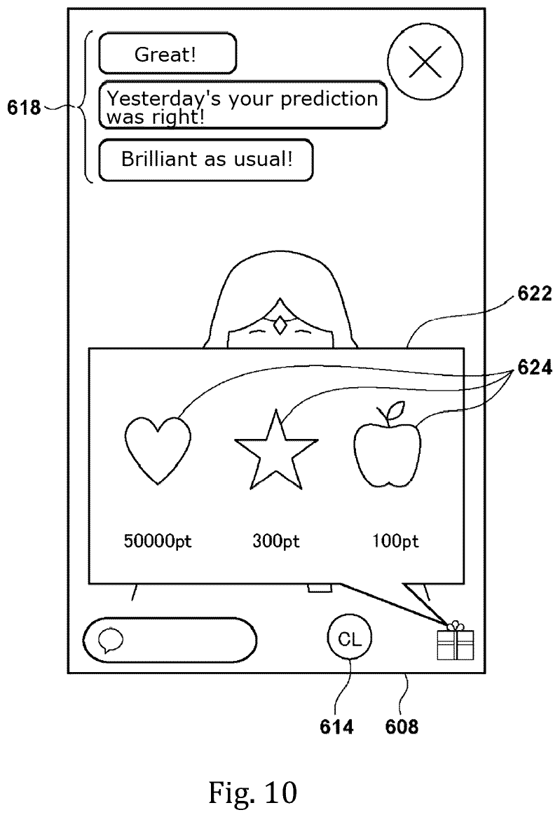

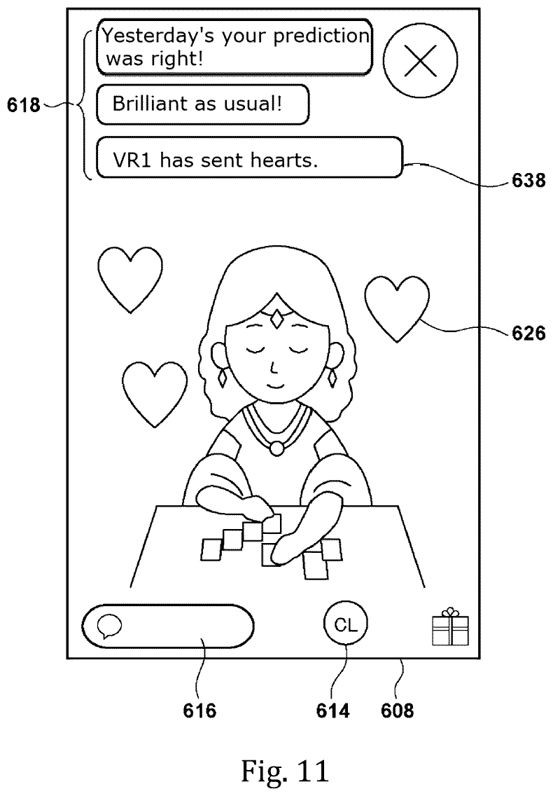

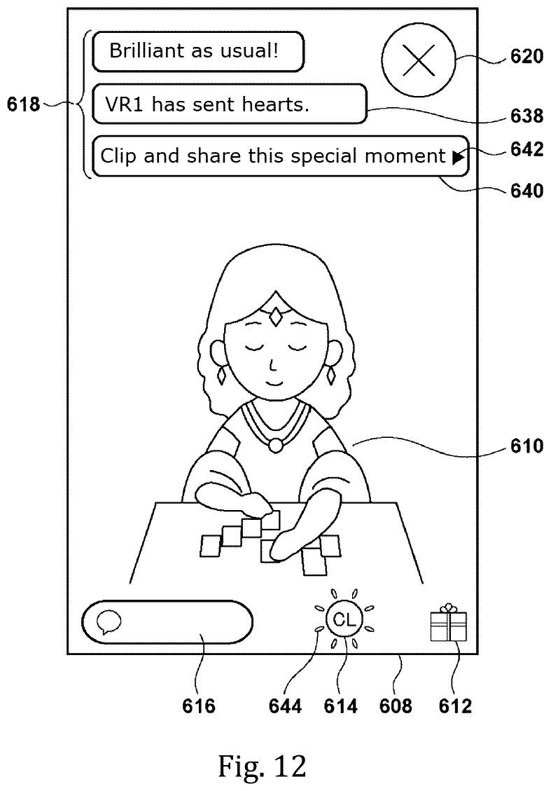

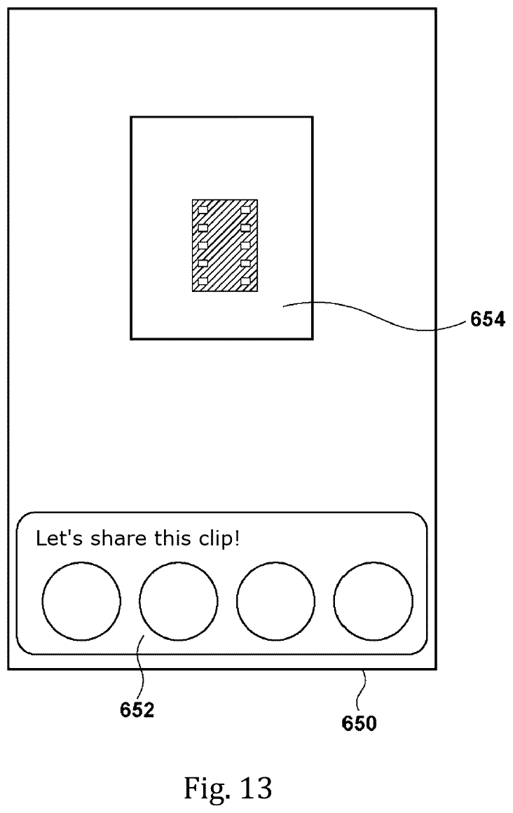

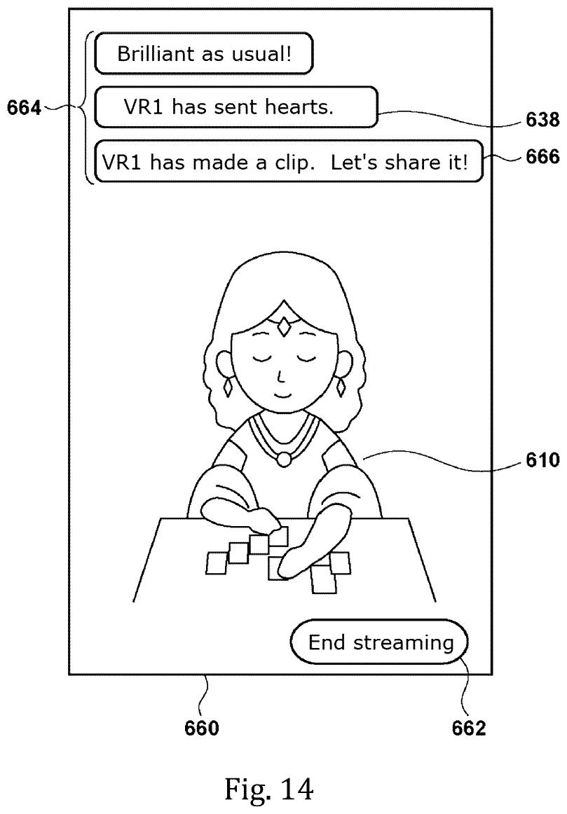

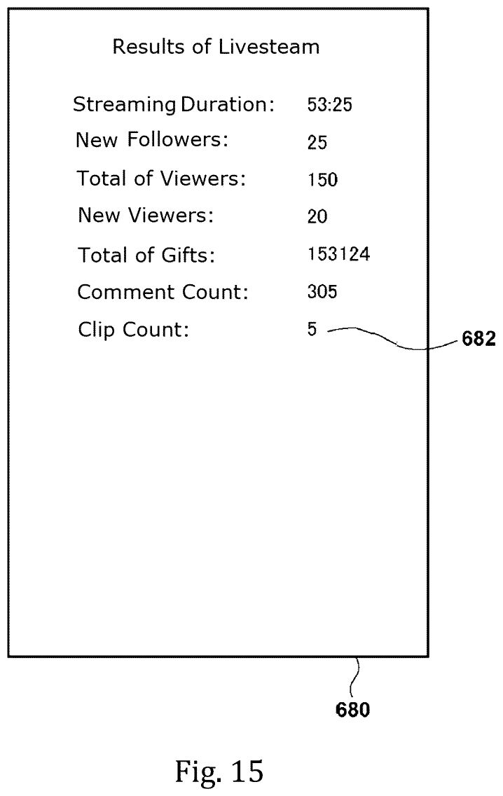

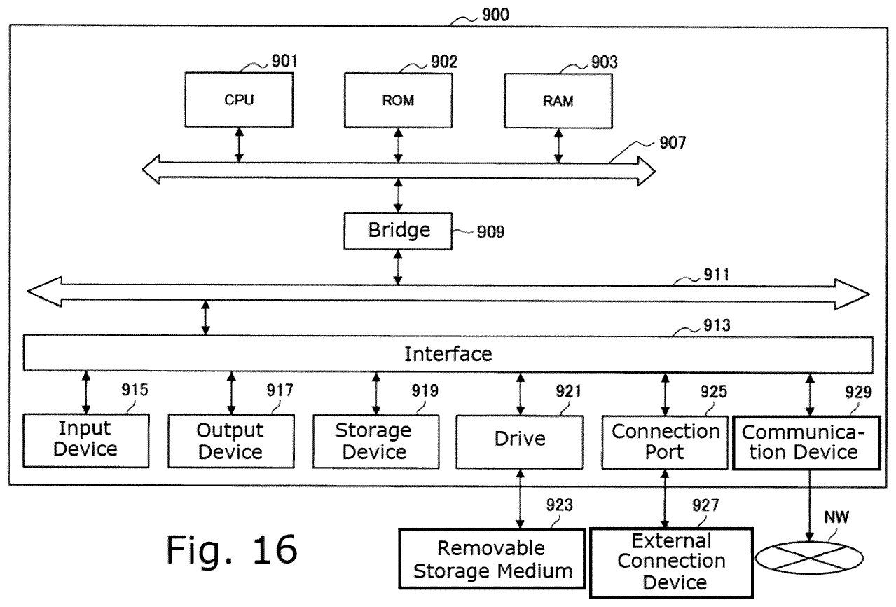

FIG. 7 is a data structure diagram of an example of the clip DB 332 in FIG. 3. The clip DB 332 holds information on clips created in the livestreaming system 1. The clip DB 332 holds a clip ID identifying a clip, data of the clip, a creator ID, which is a user ID identifying the user (viewer) who has created the clip, a stream ID identifying a livestream from which the clip has been created, start and end times of the clip in the livestream, and a trigger gift ID that is recorded if the corresponding clip is created in response to a clip prompt notification, the trigger gift ID being a gift ID identifying a gift that results in the clip prompt notification, in association with each other. The clip ID may be a URL.

Data of a clip includes video data related to a portion of a livestream from which the clip is created. The video data includes video data generated by the livestreamer's user terminal and data of objects such as gift effects and comments superimposed on the video.

Referring to the example shown in FIG. 7, a clip “CL1” is a video of 60 seconds that is obtained by a viewer “VR1” of a livestream “ST1” by clipping a portion of the livestream “ST1” starting at 2:34 (two minutes and thirty-four seconds after the start of the livestream) to 3:34 (three minutes and thirty-four seconds after the start of the livestream.) The clip “CL1” is created in response to a clip prompt notification that is sent to all of the viewers as a result of a use of an expensive gift “GFT3.”

Referring again to FIG. 3, upon reception of a notification from the user terminal 20 of the livestreamer that the livestreamer starts a livestream over the network NW, the stream information providing unit 302 enters in the stream DB 314 a stream ID identifying this livestream and the livestreamer ID of the livestreamer who delivers the livestream. In addition, the stream information providing unit 302 starts recording the livestream for generating archived data. The stream information providing unit 302 obtains in real-time the video data generated by the livestreamer of the livestream and the data of the objects such as gift effects and comments superimposed on the video and stores the obtained data in the stream DB 314 as archived data. In the present embodiment, the server 10 is configured to allow the livestreamer to, when starting a livestream, choose whether archived data should be stored for the livestream. When the livestreamer chooses that no archived data should be stored, no archived data is stored. As a result, generation of clips, which is based on archived data, is banned or limited.

When the stream information providing unit 302 receives a request for information about livestreams from the out-of-stream communication unit 404 of a user terminal of an active user over the network NW, the stream information providing unit 302 refers to the stream DB 314 and makes a list of currently available livestreams. The stream information providing unit 302 transmits the generated list to the requesting user terminal over the network NW. The out-of-stream UI control unit 402 of the requesting user terminal generates a livestream selection screen based on the received list and shows the livestream selection screen on the display of the user terminal.

Once the out-of-stream UI control unit 402 of the user terminal receives the active user's selection of a livestream on the livestream selection screen, the out-of-stream UI control unit 402 generates a stream request including the stream ID of the selected livestream, and transmits the stream request to the server 10 over the network NW. The stream information providing unit 302 starts providing, to the requesting user terminal, the livestream identified by the stream ID included in the received stream request. The stream information providing unit 302 updates the stream DB 314 such that the user ID of the active user of the requesting user terminal is included in the viewer IDs associated with the stream ID. In this way, the active user can be a viewer of the selected livestream.

The relay unit 304 relays the video data from the livestreamer's user terminal 20 to the viewer's user terminal 30 in the livestream started by the stream information providing unit 302. The relay unit 304 receives, from the livestreamer's user terminal 20 over the network NW, the video data related to the livestream and transmits the received video data to the viewer's user terminal 30. When the livestream is watched by a plurality of viewers, the relay unit 304 transmits, over the network NW, the video data related to the livestream to a plurality of user terminals of the plurality of viewers.

The relay unit 304 receives from the viewer-side communication unit 204 a signal that represents user input by a viewer during the livestream or reproduction of the video data. The signal that represents user input may be an object specifying signal for specifying an object displayed on the display of the user terminal 30, and the object specifying signal includes the viewer ID of the viewer, the livestreamer ID of the livestreamer delivering the livestream that the viewer watches, and an object ID that identifies the object. When the object is a gift icon, the object ID is a gift ID. The object specifying signal in that case is a gift use signal indicating that the viewer uses a gift for the livestreamer. Similarly, the relay unit 304 receives from the streamer-side communication unit 110 of the streaming unit 100 in the user terminal 20 a signal that represents user input by the livestreamer during reproduction of the video data, such as the object specifying signal.

The gift processing unit 308 performs processing related to a gift used during a livestream. The gift processing unit 308 updates the user DB 318 so as to increase the reward for the livestreamer according to the reward to be awarded of the gift identified by the gift ID included in the gift use signal. Specifically, the gift processing unit 308 refers to the gift DB 320 to specify a reward to be awarded for the gift ID included in the received gift use signal. The gift processing unit 308 then updates the user DB 318 to add the specified reward to be awarded to the reward for the livestreamer ID included in the gift use signal. The gift processing unit 308 performs the processing described with reference to FIG. 6 in relation to the special gifts.

The payment processing unit 310 processes payment of a price of the gift by the viewer in response to reception of the gift use signal. Specifically, the payment processing unit 310 refers to the gift DB 320 to specify the price points of the gift identified by the gift ID included in the gift use signal. The payment processing unit 310 then updates the user DB 318 to subtract the specified price points from the points of the viewer identified by the viewer ID included in the gift use signal.

The condition judging unit 322 determines whether a clip prompt notification condition is satisfied. The clip prompt notification condition is related to gifting and/or comments made during a livestream. The condition judging unit 322 monitors a livestream to see if a target event related to gifting and/or comments occurs. On detection of occurrence of a target event, the condition judging unit 322 determines that a clip prompt notification condition is satisfied.

A target event is not related to whether an instruction is made by a viewer of a livestream to create a clip. No target event is detected if an instruction is made by a viewer of a livestream to create a clip. Since a target event is expected to occur during a livestream, it does not include the starting of the livestream by the livestreamer. On a livestreaming room screen displayed on the viewer's user terminal, which will be described below, a clip icon is always present. The clip icon, however, appears independently from a clip prompt notification that may be issued as a result of detecting a target event. A target event is configurable by the administrator and contingent on gifting or comments.

The target event can be exemplified as follows.

(1) A gift satisfying a predetermined condition is used during a livestream. Gifts satisfying a predetermined condition include special gifts different from normal gifts. More specifically, gifts satisfying a predetermined condition include gifts that can be purchased at a price equal to or greater than a threshold value and interactive gifts. Referring to the example shown in FIG. 6, upon usage of an expensive gift “GFT3” priced at points of “50000” exceeding a threshold value (=30000), the condition judging unit 322 detects occurrence of a target event and determines that a clip prompt notification condition is satisfied. Upon usage of an interaction gift “RedE”, the condition judging unit 322 also detects occurrence of a target event and determines that a clip prompt notification condition is satisfied.

(2) Gifting leads to a drawing, the result of which is a win. Referring to the example shown in FIG. 6, when usage of a random gift “RAN1” leads to a drawing and the result is 1000 points, i.e., a win, the condition judging unit 322 detects occurrence of a target event and determines that a clip prompt notification condition is satisfied. The usage of the random gift “RAN1” may leads to a drawing but the result may not be a win (i.e., 100 or 200 points). In this case, the condition judging unit 322 does not detect occurrence of a target event.

(3) The manner of gifting during a livestream satisfies a predetermined condition. For example, when the number of gifts used within a predetermined period of time, such as 10 seconds or one minute exceeds a threshold value, when a particular combination of gifts is successfully accomplished, or when a gifting-related parameter of a livestream reaches a satisfying number, the condition judging unit 322 detects occurrence of a target event and determines that a clip prompt notification condition is satisfied.

(4) The manner of commenting satisfies a predetermined condition. For example, when the number of comments posted within a predetermined period of time such as 10 seconds or one minute exceeds a threshold value, the condition judging unit 322 detects occurrence of a target event and determines that a clip prompt notification condition is satisfied.

(5) The score of a livestream exceeds a threshold value. The score of a livestream rises as gifting and/or commenting increases. When the score exceeds a threshold value, the condition judging unit 322 detects occurrence of a target event and determines that a clip prompt notification condition is satisfied.

(6) The manner of gifting satisfies a predetermined condition, and the manner of commenting also satisfies a predetermined condition.

In the present embodiment, a common target event is set for all livestreamers or livestreams. In other embodiments, however, different target events may be set for individual livestreamers, individual groups of livestreamers or individual livestreams. For example, new and experienced livestreamers feel special when receiving different amounts of gifts. In view of this, the threshold value for the prices of gifts base on which the gifts are determined as to whether they are expensive gifts may depend on the levels of livestreamers. For example, the condition judging unit 322 may determine that a clip prompt notification condition is satisfied if the gift used in a livestream is priced at points of 10000 or more for a livestreamer reaching a level of 10 or less. On the other hand, the condition judging unit 322 may determine that a clip prompt notification condition is satisfied if the gift used in a livestream is priced at points of 50000 or more for a livestreamer achieving a level higher than 10.

In the present embodiment, the condition judging unit 322 determines if a clip prompt notification condition is satisfied in a rule-based manner. In other embodiments, however, machine learning may be used. For example, a machine learning model may be loaded and trained with learning data including the data of past livestreams that indicates the relationship between the number of clips and gifting and/or commenting behaviors. The machine learning model thus can output an anticipated number of clips upon receiving an input of data indicating gifting and/or commenting behaviors in a current livestream. The server may be configured to transmit a clip prompt notification to the viewers if the thus output number of clips exceeds a threshold value. The number of clips may change in different manners for different livestreamers. In view of this, machine learning models may be generated for individual livestreamers.

The clip prompt notification unit 324 sends a clip prompt notification to the user terminals of all of the viewers of a current livestream over the network NW if the current livestream is determined to have satisfied the clip prompt notification condition. Sending of the clip prompt notification from the clip prompt notification unit 324 may be triggered by satisfaction of the clip prompt notification condition. The clip prompt notification is designed to allow the viewers to issue an instruction to create a clip from the current livestream in association with the viewers.

The clip prompt notification may be sent to the user terminals of all of the viewers of the livestream or the user terminals of some of the viewers of the livestream. Alternatively, the livestreamer may identify in advance an attribute of viewers who are allowed to create a clip, so that a clip prompt notification may be sent only to the user terminals of the viewers having the identified attribute. For example, the livestreamer may have a blacklist or whitelist recorded on the system. The server may be configured to send, in a livestream of the livestreamer, a clip prompt notification only to the user terminals of viewers that are not listed on the blacklist, or only to the user terminals of the viewers that are listed on the whitelist. Alternatively, the server may be configured to send a clip prompt notification only to the viewers who follow or subscribe to the livestreamer. Alternatively, the server may refer to a list of viewers who are prohibited from posting comments or a list of viewers with limited activities, which is managed by the administrator, so that no clip prompt notification is sent to the viewers who are listed on such lists. Alternatively, a clip prompt notification may be sent only to the user terminal of the viewer who has successfully satisfied a corresponding clip prompt notification condition. For example, the server may determine that a viewer has satisfied a clip prompt notification condition if the viewer uses an expensive gift while watching a livestream. The server may send a clip prompt notification only to the user terminal of the viewer who has used the expensive gift.

The clip processing unit 326 may receive a response to the clip prompt notification over the network NW from the user terminal of one of the viewers who has received the clip prompt notification. If so, the clip processing unit 326 performs a series of processes to create a clip in relation with the viewer. The creation of a clip from a livestream may be performed using the technology disclosed in the '612 Publication.

On reception of a clip creation instruction responding to a clip prompt notification, the clip processing unit 326 performs a series of processes to create a clip covering a period immediately preceding the time at which the clip prompt notification condition corresponding to the clip prompt notification is determined to be satisfied. The clip creation instruction includes a viewer ID identifying the viewer who has issued the instruction to create a clip, and a stream ID identifying the livestream that is being watched by the viewer. Referring to the example shown in FIG. 7, an expensive gift “GFT3” is used in a livestream “ST1” at a time 3:30 (i.e., three minutes and thirty seconds after the start). The condition judging unit 322 detects the usage of the expensive gift “GFT3” and determines that a clip prompt notification condition is satisfied at a time 3:34. The clip prompt notification unit 324 sends a clip prompt notification to the user terminals of the viewers. In response to the clip prompt notification, a viewer “VR1” instructs his/her own user terminal to create a clip, and the clip processing unit 326 receives a clip creation instruction from this user terminal. In a clip creation processing responding to the clip creation instruction, the end time of the clip is determined such that the clip covers a period immediately preceding the time (3:34) at which the clip prompt notification condition is determined to be satisfied. For example, the end time of the clip is fixed to the time at which the clip prompt notification condition is determined to be satisfied (3:34), and the minimum value for the duration of the clip is set at sixty seconds. Accordingly, the clip generated by the viewer “VR1” covers a period starting at 2:34 and ending at 3:34, which includes the time 3:30 at which the expensive gift “GFT3” is used.

The clip processing unit 326 may create a clip while interacting with the creator (=the viewer) via clip generation interface, or entirely automatically create a clip in response to the clip creation instruction.

The clip processing unit 326 records, in the clip DB 332, the data of the created clip in association with the user ID identifying the creator of the clip (=the viewer who has sent the clip creation instruction), the stream ID identifying the livestream from which the clip is created, the start and end time of the clip, and the gift ID identifying the trigger gift. In relation with the above-mentioned example shown in FIG. 7, the clip processing unit 326 has an entry in the clip DB 332, where the clip ID “CL1,” the data of the created clip, the creator ID “VR1” (=the viewer who has instructed the generation of the clip), the stream ID “ST1,” the start time “2:34,” the end time “3:34,” the trigger gift ID “GFT3” are associated with each other.

The clip sharing unit 328 performs processing to enable the livestreamer or viewer to share a clip with others in the livestreaming platform or a different SNS or messaging service platform. Once the clip processing unit 326 creates a clip and records it in the clip DB 332, the clip sharing unit 328 generates a clip ID or URL for the clip and sends it to the user terminal of the creator. The creator may post the URL on a desired platform, thereby sharing the clip with others. If a person designates the shared URL on his/her own terminal, the clip sharing unit 328 provides the data of the clip corresponding to the designated URL to the terminal of the person. If the livestream from which the clip associated with the designated URL is created is currently taking place, the clip sharing unit 328 also provides the information necessary to view the livestream to the terminal of the person. The clip sharing unit 328 may send the URL for the clip to the livestreamer hosting the livestream from which the clip is created.

The stream analyzing unit 330 monitors a livestream and updates the parameter of the livestream. Upon the end of the livestream, the stream analyzing unit 330 sends the final value of the parameter of the livestream to the user terminal of the livestreamer of the livestream over the network NW. The final value of the parameter obtained by the stream analyzing unit 330 includes the final value of the clip count for the livestream that has ended.

The operation of the livestreaming system 1 with the above configuration will be now described. FIG. 8 is a flow chart showing a series of steps of a process performed in the livestreaming system 1 when a clip prompt notification is issued during a livestream. The server 10 monitors the state of a livestream that is currently taking place to judge whether a clip prompt notification condition is satisfied (S202). If the clip prompt notification condition is not satisfied (N: S202), the server 10 continues monitoring the livestream and performs the judging step S202 again. If the clip prompt notification condition is satisfied (Y: S202), the server 10 sends a clip prompt notification to user terminals of all of the viewers of the livestream (S204). The server 10 receives a clip creation instruction from one of the user terminals to which the clip prompt notification is sent in the step S201 (S206). The server 10 performs a clip creation process (S208). The server 10 records the data of the created clip in the clip DB 332 and sends the information necessary to identify the created clip to the user terminal of the viewer who has instructed the creation of the clip.

The user terminal of the viewer receives the URL for the clip, and the viewer shares the clip with other people by operating the user terminal. In this case, the user terminal performs a clip sharing process (S210). The server 10 generates a clip creation notification indicating that a clip has been created from the livestream and the URL for the created clip, and sends the clip creation notification to the user terminal of the livestreamer delivering the livestream (S212). The user terminal of the livestreamer receives the clip creation notification, and the livestreamer shares the clip with other people by operating the user terminal. In this case, the user terminal performs a clip sharing process (S214). The server 10 updates the stream DB 314 such that the clip count associated with the livestream from which the clip is generated in the step S208 is increased by one (S216).

FIG. 9 is a representative screen image of a livestreaming room screen 608 shown on the display of the viewer's user terminal 30. The viewer may tap one of the thumbnails on a livestream selection screen (not shown), and the livestreaming room screen 608 of FIG. 9 may be then shown on the display. The livestreaming room screen 608 displays a video image generated by the user terminal 20 of the livestreamer in real time. The livestreaming room screen 608 includes a video image 610 of a livestreamer obtained by reproducing the video data received from the server 10, a gift object 612, a comment input region 616, a comment display region 618, a quit viewing button 620, and a clip icon 614. The viewer-side UI control unit 202 superimposes other objects such as the gift object 612, the comment input region 616, the comment display region 618, the quit viewing button 620, and the clip icon 614 on the video image 610 obtained by reproducing the video data to generate the livestreaming room screen 608. The clip icon 614 appears on the livestreaming room screen 608 independently from whether a clip prompt notification is issued since when the user terminal 30 of the viewer start showing the livestreaming room screen 608.

The comment display region 618 may include a comment entered by the viewer, comments entered by other viewers, and system comments. The system comments may include a comment indicating who gives which gift to the livestreamer, and a comment encouraging the viewer to create a clip. The viewer-side UI control unit 202 generates the comment display region 618 including comments of other viewers and system comments received from the server 10, and the viewer-side UI control unit 202 includes the generated comment display region 618 in the livestreaming room screen 608.

The comment input region 616 receives a comment input by the viewer. The viewer-side communication unit 204 generates a comment input signal that includes the comment entered in the comment input region 616, and transmits the signal to the server 10 over the network NW. At the same time, the viewer-side UI control unit 202 updates the comment display region 618 to display the comment entered in the comment input region 616.

The quit viewing button 620 is an object for accepting an instruction from the viewer to quit viewing the livestream.

The clip icon 614 is an object for accepting an instruction from the viewer of the livestream to create a clip. The clip icon 614 appears on the livestreaming room screen 608 independently from whether or not the clip prompt notification condition is satisfied. When a tap on the clip icon 614 is detected, the viewer-side UI control unit 202 of the user terminal 30 generates a clip creation instruction including the viewer ID identifying the viewer and the stream ID of the livestream, and transmits the clip creation instruction to the server 10 over the network NW. On reception of the clip creation instruction, the clip processing unit 326 of the server 10 performs a clip creation process. The clip created in this manner is recorded in the clip DB 332 as a clip that is derived from other triggers than a clip prompt notification. Specifically, no trigger gift ID is associated with the data of the clip created in this manner (see the clip “CL5” in FIG. 7).

When a tap on the gift object 612 is detected, the viewer-side UI control unit 202 of the user terminal 30 generates a gift information request and transmits the request to the server 10 over the network NW. Upon receipt of the gift information request, the relay unit 304 of the server 10 refers to the gift DB 320 and specifies available gift IDs. The server 10 generates gift information that includes the specified gift IDs, and transmits it to the user terminal 30 of the requester. The viewer-side UI control unit 202 of the user terminal 30 generates a gift region 622 for receiving a gift selection based on the received gift information. The gift region 622 includes gift objects representing the gifts specified by the gift IDs included in the gift information. The viewer-side UI control unit 202 displays the generated gift region 622 on the livestreaming room screen 608.

FIG. 10 is a representative screen image of the livestreaming room screen 608 on which the gift region 622 is superimposed on the display of the viewer's user terminal 30. The gift region 622 includes gift objects 624 of gifts. Once the viewer taps a gift object 624 corresponding to an expensive gift “GFT3” in the gift region 622 on the livestreaming room screen 608 of FIG. 10, the viewer-side UI control unit 202 of the user terminal 30 accepts the selection of the gift object 624 made by the viewer. The viewer-side UI control unit 202 generates an effect 626 corresponding to the expensive gift “GFT3” represented by the designated gift object 624. The viewer-side UI control unit 202 displays the generated effect 626 on the livestreaming room screen 608. Concurrently, the viewer-side communication unit 204 generates a gift use signal including the gift ID of the expensive gift “GFT3” represented by the designated gift object 624 and transmits it to the server 10. The server 10 sends an effect display instruction signal including the gift ID of the expensive gift “GFT3” to the user terminal 20 of the livestreamer and the user terminals of the other viewers, so that the same effect appears on the user terminals of the livestreamer and other viewers participating in the livestream.

FIG. 11 is a representative screen image of the livestreaming room screen 608 on which the effect 626 is superimposed on the display of the viewer's user terminal 30. The comment display region 618 of FIG. 11 includes a system comment 638 telling that a viewer (user ID “VR1” in this example) has given an expensive gift (“heart” in this example) to the livestreamer. The system comment 638 may be included in a reply to the object specifying signal described above.

The server 10 detects an event in which the expensive gift “GFT3” has been used in the livestream taking place in the livestreaming room screen 608 shown in FIG. 11, and determines that a clip prompt notification condition has been satisfied. The server 10 sends a clip prompt notification to the user terminals 30 of all of the viewers participating in the livestream. Based on the received clip prompt notification, the viewer-side UI control unit 202 of the user terminal 30 starts showing something that encourages the viewer to issue an instruction to create a clip, on the livestreaming room screen 608. On reception of the clip prompt notification, the viewer-side UI control unit 202 generates a system comment 640 including a text that encourages the viewer to create a clip and shows the generated system comment 640 in the comment display region 618. The clip prompt notification may include what is to be said in the system comment 640.

FIG. 12 is a representative screen image of the livestreaming room screen 608 that includes the system comment 640 encouraging clip creation in the comment display region 618, displayed on the display of the viewer's user terminal 30. The system comment 640 includes an action icon 642. On reception of the clip prompt notification, the viewer-side UI control unit 202 of the user terminal 30 starts showing the clip icon 614 in an exaggerated manner. The clip icon 614 appears in an exaggerated manner for a predetermined period of time. Referring to the example shown in FIG. 12, the clip icon 614 is surrounded by a flashing object 644 for exaggeration.

When a tap on the action icon 642 or a tap on the clip icon 614 appearing in an exaggerated manner is detected, the viewer-side UI control unit 202 of the user terminal 30 generates a clip creation instruction including the viewer ID identifying the viewer and the stream ID of the livestream, and transmits the clip creation instruction to the server 10 over the network NW. On reception of the clip creation instruction, the clip processing unit 326 of the server 10 performs a clip creation process. The clip created in this manner is recorded in the clip DB 332 as a clip that is derived from a clip prompt notification, as described above.

In the present embodiment, the viewer is invited to create a clip by (1) the system comment 640 shown in the comment display region 618 to encourage the viewer to create a clip, and (2) the existing clip icon 614 appearing in an exaggerated manner. The present invention, however, is not limited to such, and only one of them may be employed. Alternatively or additionally, on reception of the clip prompt notification, the viewer-side UI control unit 202 may start displaying in the livestreaming room screen 608 a new icon (different from the clip icon 614) relating to creation of a clip.

FIG. 13 is a representative screen image of a clip share screen 650 shown on the display of the viewer's user terminal 30. The clip creation process starts in response to a tap on the clip icon 614 or action icon 642 on the livestreaming room screen 608 shown in FIG. 12. On completion of the clip creation, the clip share screen 650 shown in FIG. 13 appears on the display of the user terminal 30. The clip share screen 650 includes a clip object 654 representing the created clip, and a share acceptance region 652 including a plurality of icons representing a plurality of platforms on which the clip can be shared. The viewer who has created the clip may select and tap an icon corresponding to a desired one of the platforms from the icons shown in the share acceptance region 652. As a result, the viewer-side communication unit 204 generates a share request including the URL for the clip and the information identifying the platform corresponding to the selected icon, and sends the share request to the server 10 over the network NW. In response to the received share request, the clip share unit 328 of the server 10 performs a clip share process. The clip can be shared in the above-described manner using known techniques.

FIG. 14 is a representative screen image of a livestreaming room screen 660 shown on the display of the livestreamer's user terminal 20. The livestreaming room screen 660 includes a video image 610 of the livestreamer, a quit livestreaming button 662, and a comment display region 664. The comment display region 664 includes a system comment 638 telling that a viewer (user ID “VR1” in this example) has given an expensive gift (“heart” in this example) to the livestreamer, and a system comment 666 indicating that a viewer (the user ID “VR1” in this example) has generated a clip from the current livestream.

The clip creation process starts in response to a tap on the clip icon 614 or action icon 642 on the livestreaming room screen 608 shown in FIG. 12. On completion of the clip creation, the server 10 generates a clip creation notification and sends the clip creation notification to the user terminal 20 of the livestreamer. Based on the received clip creation notification, the streamer-side UI control unit 108 of the user terminal 20 starts showing something that encourages the livestreamer to issue an instruction to share the created clip, on the livestreaming room screen 660. On reception of the clip creation notification, the streamer-side UI control unit 108 generates a system comment 666 including a text that encourages the livestreamer to share the clip and shows the generated system comment 666 in the comment display region 664.

On detection of a tap on the system comment 666, the streamer-side UI control unit 108 of the user terminal 20 superimposes a share acceptance region similar or equivalent to the share acceptance region 652 of FIG. 13 on the livestreaming room screen 660, in order to receive a share request.

FIG. 15 is a representative screen image of a livestream result screen 680 shown on the display of the user terminal 20 of the livestreamer who has finished livestreaming. When the livestreamer taps the quit livestreaming button 662 on the livestreaming room screen 660 of FIG. 14, the streamer-side communication unit 110 of the user terminal 20 generates a quit livestream request and transmits it to the server 10. On reception of the quit livestream request, the server 10 finishes the livestream. The stream analyzing unit 330 sends the final values of the parameters of the finished livestream, which include the final value of the clip count, to the user terminal 20 of the livestreamer of the livestream over the network NW. The streamer-side UI control unit 108 of the user terminal 20 generates the livestream result screen 680 including the received final values and shows the generated screen on the display. The livestream result screen 680 includes a clip count display region 682 including the final value of the clip count for the finished livestream.

In the above embodiment, the DBs are illustrated by hard disks or semiconductor memories, for example. By reading the present disclosure, those skilled in the art would understand that each element or component can be realized by a CPU not shown, a module of an installed application program, a module of a system program, or a semiconductor memory that temporarily stores the contents of data read from a hard disk, and the like.

In the livestreaming system 1 relating to the present embodiment, if the clip prompt notification condition is satisfied during a livestream, the livestreaming room screen of the livestream shows an icon in an exaggerated manner or a comment to encourage the viewer to create a clip. This facilitates generation and sharing of a clip showing a special moment by the viewer. As a result, the viewer can be saved from missing the chance of creating such a clip. In addition, since the clip prompt notification is sent not only to the viewer who has triggered the occurrence of the target event (e.g., the viewer who has used an expensive gift) but to all of the viewers watching the livestream, more viewers can create a clip than in the related art, and each one of them can share the clip on any one of different platforms. The livestream from which the clip is created or its livestreamer can be spread at higher rates.

It has traditionally not been recommended for the viewer to generate a clip from a livestream, from the perspective of copyright protection and because such clipping is hard to control. The inventors of the present invention, however, have realized that a livestream or livestreamer can acquire highly improved recognition rate if the viewer is allowed to create a clip from a livestream and that the advantages overcome the disadvantages. According to the present embodiment, the system recommends that the viewer should create a clip, which is more advanced than allowing the viewer to create a clip. In this manner, the foregoing advantages can be enhanced.

In the livestreaming system 1 relating to the present embodiment, the clip prompt notification condition is satisfied if a special gift such as an expensive or interactive gift is used, or if a random gift hits a win. This can raise the probability that the viewer creates a clip including a flashy effect caused by an expensive gift, that the viewer creates a clip including lively communication caused by usage of an interaction gift, and that the viewer creates a clip showing enormous pleasure experienced by the livestreamer and viewer when a random gift hits a win. Furthermore, those remarkable moments are left in clips, which are spread by a large number of viewers to a large number of people. This can result in raising the recognition rate of the livestream or its livestreamer.

In the livestreaming system 1 relating to the present embodiment, the livestream is analyzed so that the number of clips is counted and presented to the livestreamer. In the present embodiment, the viewer is encouraged to create a clip. This may lead to an increased number of clips. Such a large number of clips may motivate the livestreamer to livestream.

Referring to FIG. 16, the hardware configuration of an information processing device relating to an embodiment of the disclosure will be now described. FIG. 16 is a block diagram showing an example of the hardware configuration of the information processing device according to the embodiment. The illustrated information processing device 900 may, for example, realize the server 10 and the user terminals 20 and 30 in the embodiment.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). The CPU 901 is an example of a hardware configuration to realize various functions performed by the components described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the image capturing control unit 102, audio control unit 104, video transmission unit 106, streamer-side UI control unit 108, streamer-side communication unit 110, viewer-side UI control unit 202, viewer-side communication unit 204, out-of-stream UI control unit 402, out-of-stream communication unit 404, stream information providing unit 302, relay unit 304, gift processing unit 308, payment processing unit 310, condition judging unit 322, clip prompt notification unit 324, clip processing unit 326, clip sharing unit 328, stream analyzing unit 330, stream DB 314, user DB 318, gift DB 320, and clip DB 332 may be embodied as circuitry programmed to realize such functions.

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the server 10 and the user terminals 20 and 30 in the embodiment. The ROM 902 stores programs, calculation parameters, and the like used by the CPU 901. The RAM 903 serves as a primary storage that stores a program used in the execution of the CPU 901, parameters that appropriately change in the execution, and the like. The CPU 901, ROM 902, and RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The configuration and operation of the livestreaming system 1 in the embodiment have been described. This embodiment is merely an example, and it will be understood by those skilled in the art that various modifications are possible by combining the respective components and processes, and that such modifications are also within the scope of the present disclosure.

In the present embodiment, the clip prompt notification is sent to the viewers of the livestream. The present invention is not limited to such. The clip prompt notification may be sent to the livestreamer in place of/in addition to the viewers.

In the present embodiment, whether the clip prompt notification condition is satisfied is determined during a livestream. The present invention is not limited to such. For example, whether the clip prompt notification condition is satisfied may be determined while the active user is watching an archived livestream. For example, the clip prompt notification condition may be determined to be satisfied if the archived livestream that is being reproduced and watched by the viewer shows a scene where an expensive gift is used, and the clip prompt notification may be sent to the user terminal of the viewer watching the archived livestream.

In the present embodiment, data of a clip includes video data generated at the user terminal of the livestreamer, and data of objects such as gift effects and comments superimposed on the video. The present invention, however, is not limited to such. Data of a clip may include video data generated at the user terminal of the livestreamer, but not data of objects.

The return rate of the gift, which indicates the ratio of the reward to be awarded to the price points in the embodiment is merely an example, and the return rate may be appropriately set by the administrator of the livestreaming system 1, for example.

The technical idea according to the embodiment may be applied to live commerce or virtual livestreaming using an avatar that moves in synchronization with the movement of the streamer instead of the image of the streamer. In the present embodiment, the video data related to the livestream that is generated at the user terminal of the livestreamer is relayed by the server and sent to the user terminal of the viewer. The present invention, however, is not limited to such. For example, the technical ideas of the present embodiment can also be applied to a virtual livestreamer in place of an actual livestreamer. A virtual livestreamer is an AI virtual livestreamer having an appearance represented by an avatar, emitting audio produced by a text-to-speech (TTS) engine, and saying what is generated by a machine learning model receiving comments posted by viewers. In this case, the livestreamer has no user terminal, and the server performs the streamer-side processes.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present invention.

At least some of the functions realized by the server 10 may be realized by a device(s) other than the server 10, for example, the user terminals 20 and 30. At least some of the functions realized by the user terminals 20 and 30 may be realized by a device(s) other than the user terminals 20 and 30, for example, the server 10. For example, the superimposition of a predetermined frame image on an image of the video data performed by the viewer's user terminal may be performed by the server 10 or may be performed by the livestreamer's user terminal. Clips may be created at the user terminal of the viewer or livestreamer, instead of the server 10.

What is claimed is:

1. A server comprising a circuitry, wherein the circuitry is configured to:
transmit video data related to a livestream to a terminal of a viewer over a network;
determine whether a condition is satisfied, the condition being related to at least one of gifting or a comment during the livestream;
send a notification to the terminal of the viewer over the network upon determination that the condition is satisfied; and
perform a process to create video data relating to a portion of the livestream in association with the viewer upon reception of a response to the notification from the terminal of the viewer over the network.

2. The server of claim 1, wherein the circuitry is configured to determine that the condition is satisfied if a gift meeting a predetermined requirement is used during the livestream.

3. The server of claim 2, wherein the gift meeting the predetermined requirement includes a gift having a price equal to or higher than a threshold value.

4. The server of claim 1, wherein the circuitry is configured to determine that the condition is satisfied if a drawing resulting from gifting hits a win.

5. The server of claim 1, wherein the circuitry is configured to send a notification to the terminal of the viewer over the network to receive an instruction, from the viewer, to create video data relating to a portion of the livestream in association with the viewer.

6. The server of claim 1, wherein the circuitry is configured to perform a process to create video data relating to a portion of the livestream that covers a period immediately preceding a time at which the condition is determined to be satisfied.

7. The server of claim 1, wherein the circuitry is configured to determine whether the condition is satisfied independently from whether an instruction is issued by the viewer to generate video data relating to a portion of the livestream.

8. The server of claim 1, wherein the circuitry is configured to:
send the video data relating to the livestream to a plurality of terminals of a plurality of viewers over the network;
send the notification to the plurality of terminals of the plurality of viewers over the network upon determination that the condition is satisfied; and
upon receiving a response responding to the notification from a terminal of a given one of the viewers over the network, perform a process to create video data relating to a portion of the livestream in association with the given one of the viewers.

9. The server of claim 8, wherein the circuitry is further configured to send information to a terminal of a livestreamer delivering the livestream over the network, the information indicating how many times video data relating to a portion of the livestream is created.

10. A terminal of a viewer of a livestream, comprising:
one or more processors; and
memory storing one or more computer programs configured to be executed by the one or more processors,
the one or more computer programs including instructions for causing the terminal of the viewer of the livestream to:
receive video data related to the livestream from a server over a network; and
upon determination that a condition relating to at least one of gifting or a comment is satisfied during the livestream, start displaying an indication, on a screen showing the livestream, encouraging the viewer to issue an instruction to create video data relating to a portion of the livestream in association with the viewer.

11. The terminal of claim 10,
wherein the indication is at least one of (i) a comment relating to creation of video data relating to a portion of the livestream in a comment display region of the screen showing the livestream, or (ii) an icon relating to creation of video data relating to a portion of the livestream on the screen showing the livestream, and
wherein the one or more computer programs include further instructions for causing the terminal of the viewer of the livestream to, upon designation of the comment or icon by the viewer, send an instruction to create video data relating to a portion of the livestream in association with the viewer, over the network to the server.

12. The terminal of claim 10,
wherein the one or more computer programs include further instructions for causing the terminal of the viewer of the livestream to display, on the screen showing the livestream, an icon configured to receive the instruction to create video data relating to a portion of the livestream in association with the viewer, independently from whether the condition is satisfied, and
wherein the indication is the icon appearing in an exaggerated manner.

13. The terminal of claim 11, wherein the one or more computer programs include further instructions for causing the terminal of the viewer of the livestream to display, on the screen showing the livestream, another icon configured to receive the instruction to create video data relating to a portion of the livestream in association with the viewer, independently from whether the condition is satisfied.

14. The terminal of claim 13, wherein the indication is the other icon appearing in an exaggerated manner.

15. A method comprising:
sending video data relating to a livestream to a terminal of a viewer over a network;
determining whether a condition is satisfied, the condition being related to at least one of gifting or a comment during the livestream;
sending a notification to the terminal of the viewer over the network upon determination that the condition is satisfied; and
performing a process to create video data relating to a portion of the livestream in association with the viewer upon reception of a response to the notification from the terminal of the viewer over the network.
